(19) United States
(12) Patent Application Publication
(10) Pub. No.: US 2009/0101014 A1
(43) Pub. Date: Apr. 23, 2009

(54) Moisture separator arrangement; fluid intake for air cleaner; and,method

(76) Inventor: Michel Baseotto, Hasselt (BE)

Correspondence Address: MERCHANT & GOULD PC, P.O. BOX 2903, MINNEAPOLIS, MN, 55402-0903, US

(21) Appl. No.: 12/214,439

(22) Filed: Jun. 19, 2008

Related U.S. Application Data
(60) Provisional application No. 60/945,235, filed on Jun. 20, 2007.

(51) Int. Cl. B01D 45/08

(52) U.S. Cl. 95/272; 55/440

(57) ABSTRACT

A moisture separator arrangement for a gas intake for an air cleaner includes a plurality of curved plates spaced apart to receive fluid flow between adjacent ones of the curved plates. Each of the curved plates includes a moisture-receiving pocket and a catch to receive and coalesce water droplets in a fluid stream flowing between the curved plates. Methods of use are provided.

### CROSS REFERENCE TO RELATED APPLICATIONS

The present application includes the disclosure of, with edits, U.S. provisional application 60/945,235 filed Jun. 20, 2007. The complete disclosure of U.S. application 60/945,235 is incorporated herein by reference. A claim of priority to U.S. application 60/945,235 is made, to the extent appropriate.

### TECHNICAL FIELD

This disclosure relates to fluid intake for an air cleaner. This disclosure particularly relates to a moisture separator arrangement for separating out water droplets from an air stream before the air stream enters the air cleaner. This arrangement is useful in engine air cleaners, amongst others.

### BACKGROUND

It is necessary to clean air when it is used in the combustion process for engines. This is because ambient air includes materials that will damage or corrode the internal parts of the engine, including, for example, the pistons and bearings. Ambient air includes particulate material, and will often include moisture in the form of water droplets. Air cleaners can include components to remove particulate and moisture. To improve the life of an air cleaner, it can be helpful to include a moisture separator to function as an initial separator to remove water droplets from the ambient air before the air stream reaches the air cleaner. Improvements in moisture separators are desirable.

### SUMMARY

A moisture separator arrangement for a gas intake for an air cleaner includes a plurality of curved plates spaced apart to receive fluid flow between adjacent ones of the curved plates. Each of the curved plates includes a moisture receiving pocket and a catch to receive and coalesce water droplets in a fluid stream flowing between the curved plates.

In certain embodiments, each of the curved plates has a primary wave section, a catch at an end of the primary wave section, and a spur extending from the primary wave section.

In certain embodiments, each of the curved plates is evenly spaced and parallel to an adjacent curved plate.

In certain embodiments, each of the curved plates includes a primary wave section having a first linear section, an arched section connected to the first linear section, and a second linear section connected to the arched section. In some embodiments, the first linear section is located at a leading edge of the curved plate and comprises less than 20 percent of an overall length of the curved plate. The arched section comprises more than 40 percent of the overall length, in certain embodiments, and the second linear section, in certain embodiments, comprises less than 40 percent of the overall length.

In some embodiments, the catch of each curved plate is at a trailing edge of each plate and is connected to the second linear section. In certain embodiments, the catch includes a cup to receive impact of moisture droplets.

In certain embodiments, the spur of each curved plate extends from the second linear section and defines a moisture receiving pocket with the arched section.

In certain embodiments, the spur of each curved plate includes an arched region with a crest that is parallel to a crest of the arched section of the primary wave section of the respective curved plate.

In certain embodiments, there are at least 20 curved plates, and in some embodiments, there are 30-60 curved plates.

In another aspect, a fluid intake for an air cleaner includes a tubular conduit adapted to be secured to a gas intake of an air cleaner. The fluid intake also includes a moisture separation unit upstream and in fluid communication with the tubular conduit. The moisture separation unit includes a plurality of curved plates spaced apart to receive fluid flow between adjacent ones of the curved plates. Each of the curved plates has a primary wave section, a catch at the end of the primary wave section, and a spur extending from the primary wave section.

In another aspect, a method of taking in a fluid stream for an air cleaner includes directing the fluid stream comprising a mixture of air and water droplets into a moisture separation unit to separate water droplets from the air stream. This step includes directing the fluid stream between a plurality of curved plates so that the water droplets impact the curved plates and coalesce on the curved plates in at least one of: (i) a moisture receiving pocket defined between a spur and a remaining portion of each curved plate; and (ii) a catch at a trailing edge of each curved plate.

### BRIEF DESCRIPTION OF THE DRAWINGS

FIG. 1 is a front elevational view of a fluid intake for an air cleaner including a tubular conduit and a moisture separation unit constructed to principles of this disclosure;

FIG. 2 is a side-elevational view of the fluid intake depicted in FIG. 1;

FIG. 3 is another side-elevational view of the fluid intake shown in FIGS. 1 and 2;

FIG. 4 is a perspective view of the moisture separation unit depicted in FIGS. 1-3;

FIG. 5 is a schematic view of curved plates utilized in the moisture separation unit and schematically depicting a fluid stream impacting the plates; and

FIG. 6 is a perspective view of curved plates utilized in the moisture separation unit of FIG. 1-5.

FIG. 7 is a schematic front elevational view analogous to FIG. 1, but shown as a line drawing.

FIG. 8 is a schematic side view of the assembly depicted in FIG. 7, and analogous to FIG. 2, but depicted as a line drawing.

FIG. 9 is a schematic perspective view of a moisture separation unit depicted in FIGS. 7 and 8; the view of FIG. 9 being analogous to former FIG. 4, but shown as a line drawing.

FIG. 10 is a schematic, fragmentary, view of curved plates usable in a moisture separation unit of FIGS. 7-9; the view of FIG. 10 being generally analogous to the view of FIG. 5, but shown as a line drawing.

FIG. 11 is a schematic fragmentary perspective view of curved plates used in the separation unit of FIG. 7-9; the view of FIG. 11 being analogous to the view of FIG. 6, but shown as a line drawing.

### DETAILED DESCRIPTION

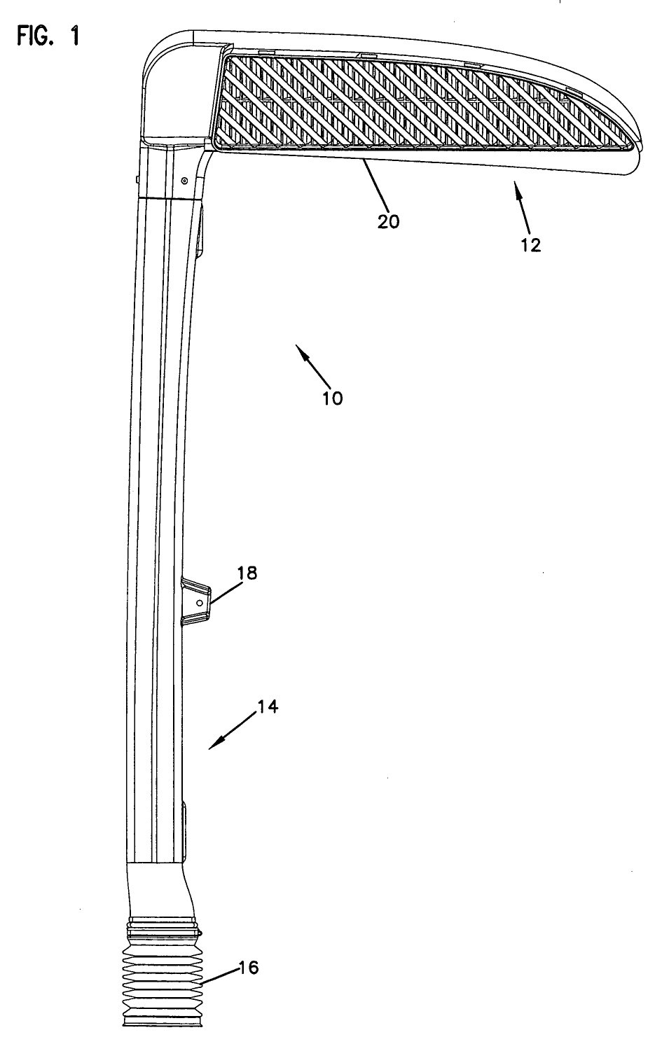

FIG. 1 depicts a side-elevational view of a fluid intake arrangement 10 for use with an air cleaner. The air cleaner will typically be usable for filtering air for use in an internal combustion engine. Other applications are contemplated. The fluid intake arrangement 10 includes a moisture separation unit 12 and a conduit 14. The conduit 14 is arranged in fluid communication and downstream of the moisture separation unit. In general, ambient air will flow through the moisture separation unit 12, which will remove at least some of the moisture including water droplets from the ambient air and the rest of the air stream will then flow through the conduit 14 and then flow into an air cleaner for filtering.

In FIG. 1, it can be seen how the conduit 14 includes features that allow it to be connected up to remaining portions of an air intake for an air cleaner, including an accordion section 16 and flanges 18 for receiving fasteners. The conduit 14 is tubular to allow for the flow of air from the moisture separation unit 12 to the air cleaner.

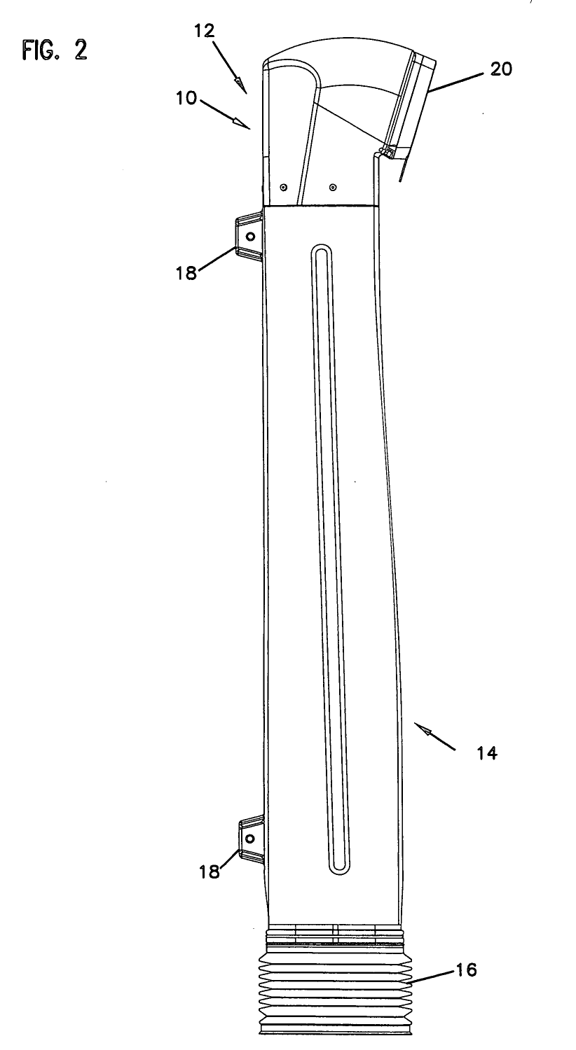

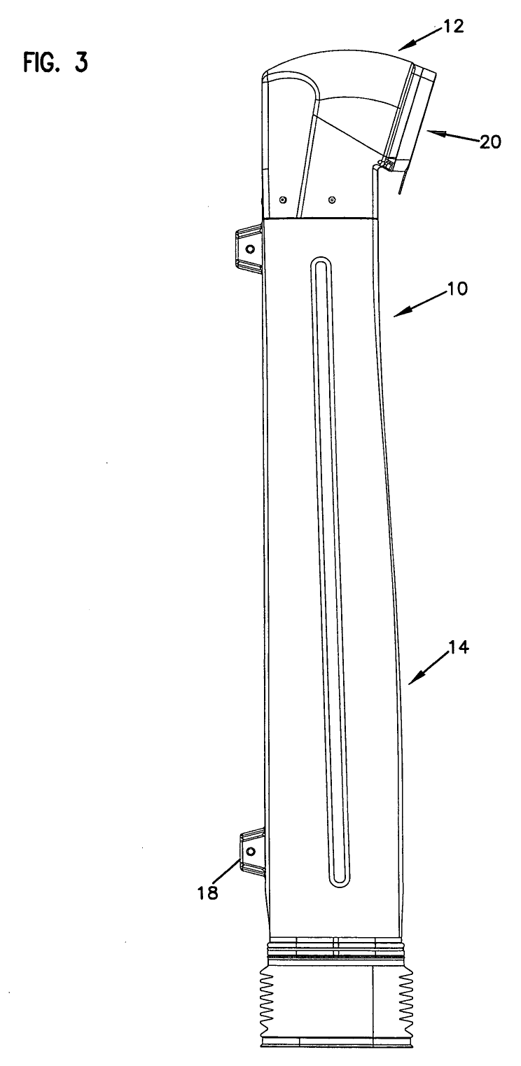

The moisture separator unit 12 includes, in general, an intake mouth area 20 for receiving ambient air, such as an air stream mixed with moisture (water droplets). FIGS. 2 and 3 are the same view of the fluid intake 10, shown as a side-elevational view of FIG. 1.

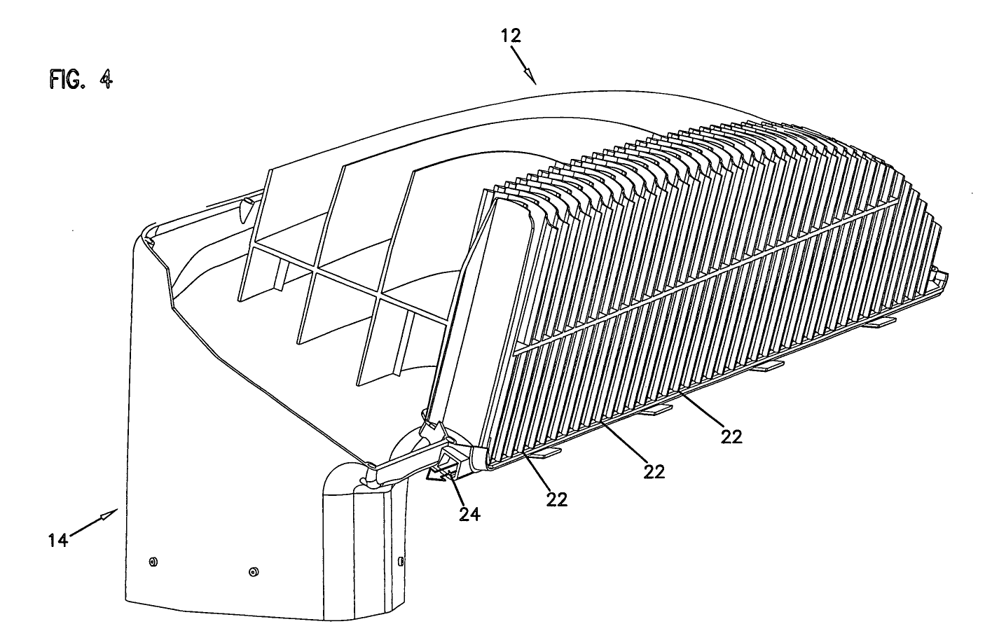

FIG. 4 is a perspective view of one embodiment of the moisture separator unit 12. In the embodiment shown in FIG. 4, the moisture separator unit 12 includes a plurality of curved plates 22 spaced apart to receive fluid flow between adjacent ones of the curved plates 22. The air stream flows between the curved plates 22, coalesces the water droplets and the water drains by gravity and can flow through a drain hole 24 within the moisture separator unit 12. After the moisture is separated, the remaining portion of the air stream is directed into the conduit 14. In FIG. 4, it can be seen how each of the curved plates 22 is generally evenly spaced and parallel to an adjacent curved plate 22. In the embodiment shown, there are at least 20 curved plates evenly spaced and arranged in a single row. In many embodiments, there will be 30-60 curved plates.

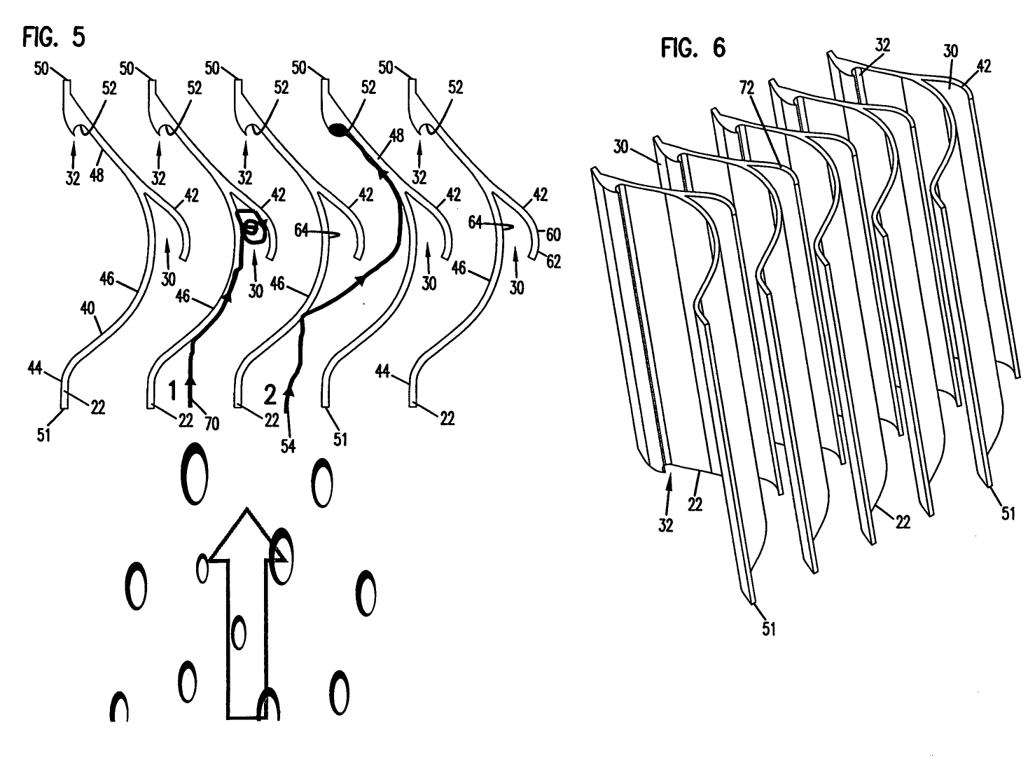

Attention is directed to FIGS. 5 and 6. In FIGS. 5 and 6, there are enlarged views of five of the curved plates 22. In the particular embodiment illustrated, each of the curved plates 22 includes a moisture-receiving pocket 30 and a catch 32 to also receive moisture. A variety of implementations are contemplated, and in the particular arrangement shown in FIG. 5, each of the curved plates 22 has a primary wave section 40, the catch 32 at the end of the primary wave section 40, and a spur 42 extending from the primary wave section 40.

In FIG. 5, it can be seen that in this embodiment, each of the primary wave sections 40 has a first linear section 44, an arched section 46 connected to the first linear section 44, and a second linear section 48 connected to the arched section 46. The first linear section 44 of the primary wave section 40 is located, in the embodiment shown, at a leading edge 51. In the embodiment shown, the first linear section 44 comprises less than 20 percent of an overall length of the curved plate 22. The arched section 46 comprises more than 40 percent of the overall length, and the second linear section 48 comprises less than 40 percent of the overall length.

The catch 32 of each of the curved plates 22 is at a trailing edge 50 of each plate 22 and is connected to the second linear section 48. The catch 32 includes a cup 52 to receive impact of moisture droplets. A droplet path is shown at 54 first impacting the arched section 46 of the primary wave section 40 of one of the plates 22 and then impacting the second linear section 48 of the primary wave section 40 of another of the plates 22 before the droplet collects within the cup 52 of the catch 32 of the same plate which it impacted the second linear section 48.

The spur 42 of each curved plate 22 extends from the second linear section 48 and defines the moisture-receiving pocket 30 as a region between the spur 42 and the arched section 46 of the primary wave section 40. In the embodiment shown, the spur 42 of each curved plate includes an arched region 60 with a crest 62 that is parallel to a crest 64 of the primary wave section 46 of the respective curved plate 22.

In FIG. 5, a droplet path 70 can be seen impacting the arched section 46 of the primary wave section 40. The droplet path 70 travels along the arched section 46 before it collects within the pocket 30 between the spur 42 and the arched section 46.

FIG. 6 is a perspective view of the plates 22 shown in FIG. 5. FIG. 6 also shows at 72 the direction of water drainage that has been collected within the pocket 30.

A method for taking in a fluid stream for an air cleaner includes directing the fluid stream comprising a mixture of air and water droplets into the moisture separation unit 12 to separate water droplets from the air stream. The method includes directing the fluid stream between the plurality of curved plates 22 so that water droplets impact the curved plates 22 and coalesce on the curved plates in at least one of two places. One of the places is the moisture-receiving pocket 30 defined between the spur 42 and a remaining portion of each curved plate 22. Another of the places is the catch 32 located at the trailing edge 50 of each curved plate 22.

Other embodiments and methods are contemplated.

### ADDITIONAL DESCRIPTION

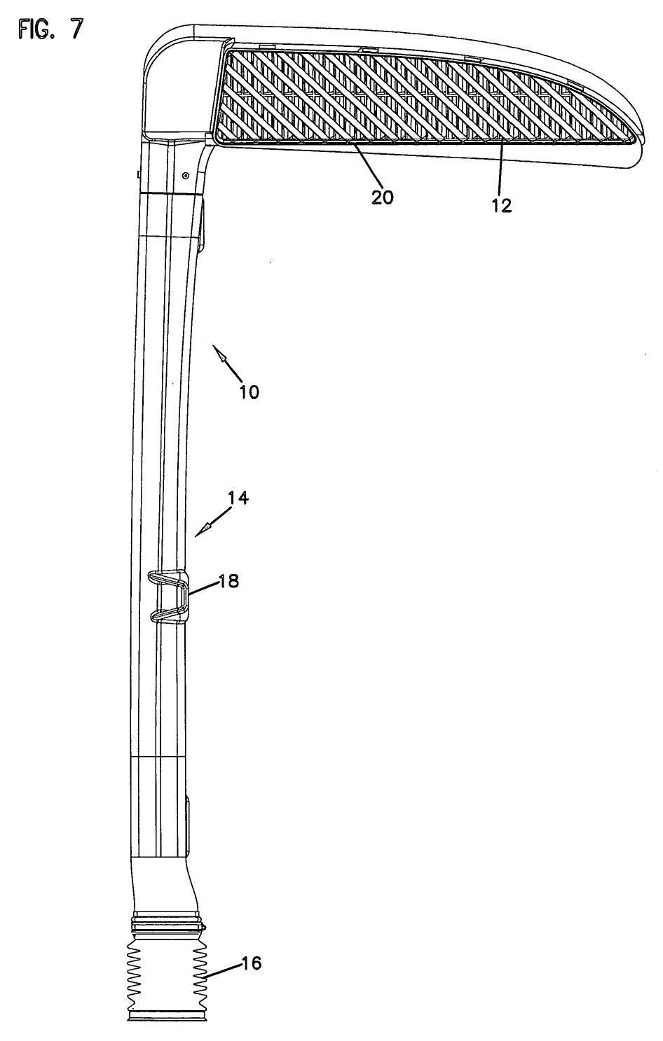

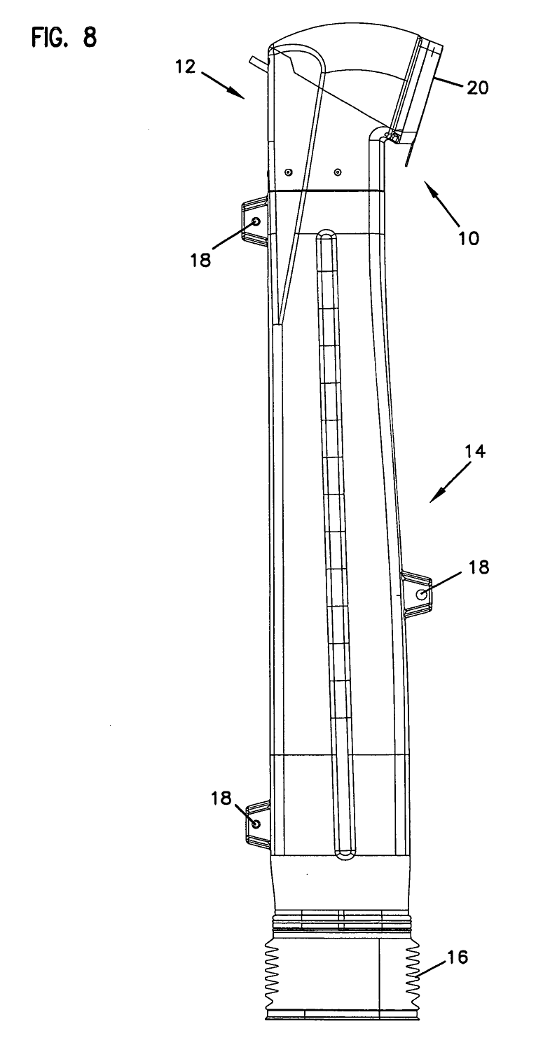

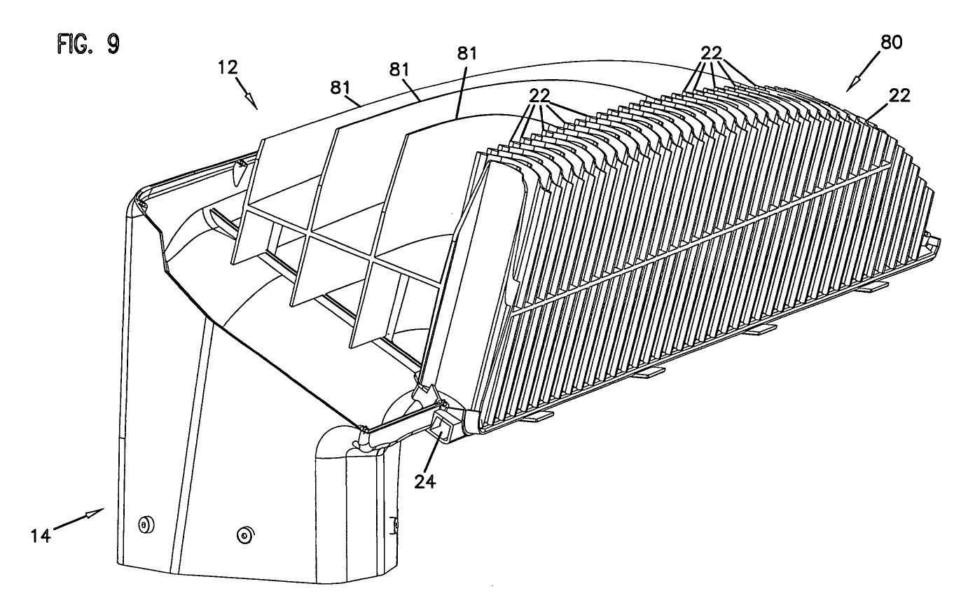

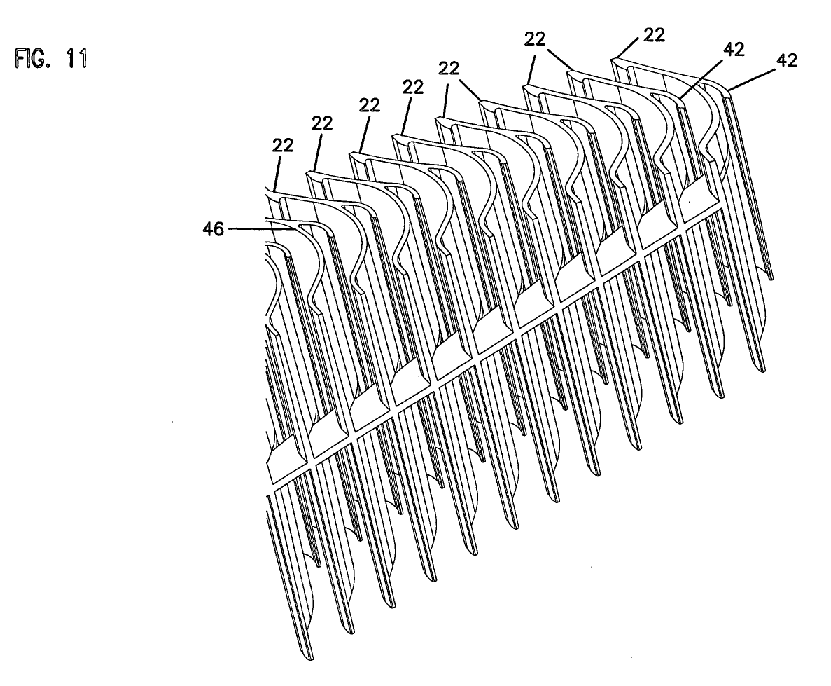

In FIGS. 7-11, some additional line drawings have been added to the drawings included in the original provisional application U.S. 60/945,235 filed Jun. 20, 2007. The drawings of FIGS. 7-11, are line drawings with features analogous to those in previously presented and discussed FIGS. 1, 2, 4, 5 and 6 respectively. Like reference numerals have been provided for like features and parts in FIGS. 7-11, and analogous definitions and descriptions to those previously given, apply.

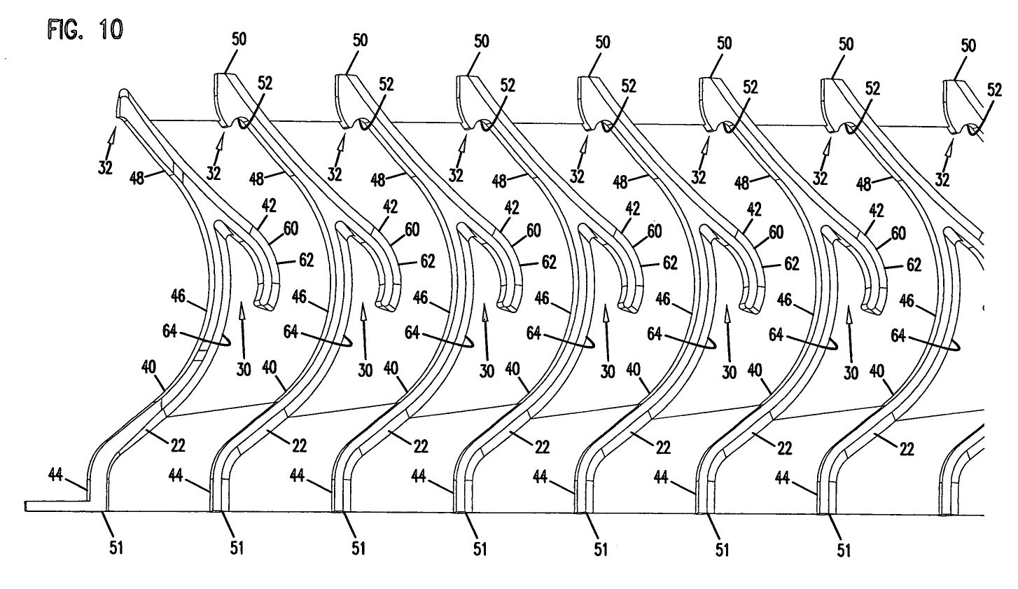

Referring to previously presented FIG. 4, and analogous currently presented FIG. 9, it is noted that not all plates 22 are the same length. In region 80, FIG. 9, and the analogous region in FIG. 4, some of the plates 22 form a region 80 of adjacent plates 22 that are tapered downwardly in length, with respect to one another, creating an end taper to unit 12.

Also it is noted that in FIG. 9, curved direction vanes 81 are viewable, turning air which is passed through plates 22, toward tube 14. Analogous, spaced, direction vanes to vanes 81 are also viewable in FIG. 4. The vanes 81, turn air passing through plates 22 through an approximately 90° arc.

It is noted that the assembly of FIG. 1, and thus the assembly of FIG. 7, is configured so that the moisture separator unit 12 is remote from, and is not included in, an air cleaner housing. Rather, unit 12 is spaced from an air cleaner housing, by conduit 14 and, for the example depicted, accordion section 16.

Alternately stated, the moisture separator unit 12 is not included within an air cleaner housing that also includes a filter cartridge. Rather, unit 12 is independent, and is enclosed within its own housing. Plates 22 could be used in an air flow inlet section of an air cleaner housing, however.

It is noted that alternate applications of the techniques and features described herein are possible, and there is no requirement that an assembly include all of the features characterized herein, in order to obtain some benefit according to the present disclosure.

We claim:

1. A moisture separator arrangement for a gas intake for an air cleaner; the moisture separator arrangement comprising:
(a) a plurality of curved plates spaced apart to receive fluid flow between adjacent ones of the curved plates; and
(b) each of the curved plates having a primary wave section, a catch at an end of the primary wave section, and a spur extending from the primary wave section.

2. A moisture separator arrangement according to claim 1 wherein:
(a) each of the curved plates is evenly spaced and parallel to an adjacent curved plate.

3. A moisture separator arrangement according to claim 1 wherein:
(a) each of the curved plates includes:
(i) the primary wave section having a first linear section at a leading edge comprising less than 20% of an overall length; an arched section connected to the first linear section and comprising more than 40% of an overall length; and a second linear section connected to the arched section comprising less than 40% of an overall length.

4. A moisture separator arrangement according to claim 3 wherein:
(a) the catch of each curved plate is at a trailing edge of each plate and is connected to the second linear section; the catch including a cup to receive impact of moisture droplets.

5. A moisture separator arrangement according to claim 4 wherein:
(a) the spur of each curved plate extends from the second linear section and defines a moisture receiving pocket with the arched section.

6. A moisture separator arrangement according to claim 5 wherein:
(a) the spur of each curved plate includes an arched region with a crest that is parallel to a crest of the arched section of the primary wave section of the respective curved plate.

7. A moisture separator arrangement according to claim 1 wherein:
(a) there are at least 20 curved plates.

8. A moisture separator arrangement according to claim 1 wherein:
(a) there are 30-60 curved plates.

9. A fluid intake for an air cleaner; the fluid intake comprising:
(a) a tubular conduit adapted to be secured to a gas intake of an air cleaner; and
(b) a moisture separation unit upstream of and in fluid communication with the tubular conduit; the moisture separation unit including:
(i) a plurality of curved plates spaced apart to receive fluid flow between adjacent ones of the curved plates; and
(ii) each of the curved plates having a primary wave section, a catch at an end of the primary wave section, and a spur extending from the primary wave section.

10. A method of taking in a fluid stream for an air cleaner; the method comprising:
(a) directing the fluid stream comprising a mixture of air and water droplets into a moisture separation unit to separate water droplets from the air stream, including:
(i) directing the fluid stream between a plurality of curved plates so that water droplets impact the curved plates and coalesce on the curved plates in at least one of:
(A) a moisture receiving pocket defined between a spur and a remaining portion of each curved plate; and
(B) a catch at a trailing edge of each curved plate.
